(19) United States
(12) Patent Application Publication
(10) Pub. No.: US 2008/0040159 A1
(43) Pub. Date: Feb. 14, 2008

(54) SYSTEMS AND METHODS FOR SHARED DECISION MAKING

(76) Inventor: Patricia E. Deegan, Byfield, MA (US)

Correspondence Address: FISH & RICHARDSON PC, P.O. BOX 1022, MINNEAPOLIS, MN, 55440-1022, US

(21) Appl. No.: 11/684,730

(22) Filed: Mar. 12, 2007

Related U.S. Application Data
(60) Provisional application No. 60/815,719, filed on Jun. 22, 2006.

(51) Int. Cl. G06F 19/00

(52) U.S. Cl. 705/3

(57) ABSTRACT

This invention relates to techniques for treatment of long term disorders such as psychiatric disorders.

### CROSS-REFERENCE TO RELATED APPLICATIONS

This application claims priority from and incorporates herein U.S. Provisional Application No. 60/315,719, filed Jun. 22, 2006, and titled “Point-of-Care System and Method”.

### BACKGROUND

Unilateral decision making in psychiatry has led to high rates of treatment non-concordance. Lack of treatment concordance can translate into increased healthcare costs and poorer treatment outcomes.

### SUMMARY

According to an aspect of the present invention, a method for use in treating a psychiatric disorder includes generating by a computer a user interface. The user interface includes a plurality of questions phrased from the point of view of a psychiatric patient. The method also includes displaying the user interface on a display device and receiving responses from the psychiatric patient to the plurality of questions. The method also includes generating a report based on the responses.

Embodiments can include one or more of the following.

The method can include generating a suggested intervention based on the responses. Generating the plurality of questions in the user interface can include generating a question about the psychiatric patient performance of a non-pharmacological activity used to assist the psychiatric patient in recovery. Receiving responses from the psychiatric patient can include receiving an indication of the extent to which the psychiatric patient has performed the activity.

Generating the plurality of questions in the user interface can include generating a statement of a shared decision, the shared decision being an activity to be performed by the psychiatric patient that was previously determined by the patient and doctor. Receiving responses from the psychiatric patient can include receiving an indication from the psychiatric patient regarding whether the psychiatric patient performed the shared decision.

Generating the plurality of questions in the user interface can include generating a plurality of questions regarding the extent to which the patient encountered symptoms associated with the psychiatric disorder. Receiving responses from the psychiatric patient can include receiving an indication from the psychiatric patient of the extent to which the psychiatric patient encountered the symptoms.

Generating the plurality of questions in the user interface can include generating one or more questions related to the use of prescribed medications. Receiving responses from the psychiatric patient can include receiving responses from the psychiatric patient regarding the use of the prescribed medications. Generating one or more questions related to the use of prescribed medications can include presenting the user with input options that indicate whether the patient used the medication as prescribed, the input options including at least some of yes, no, used more, used less, and did not start. The method can also include determining if the psychiatric patient used a particular medication as prescribed based on the response from the psychiatric patient. If the user did not use the particular medication as prescribed, the method can include generating a list of common concerns related to the user of the medication. The method can also include presenting the list of common concerns to the psychiatric patient on the user interface and receiving a response from the user, the response indicating the degree to which the patient has the concern.

Generating the plurality of questions in the user interface can include presenting the psychiatric patient with a list of potential goals for a meeting with a doctor. Receiving responses from the psychiatric patient can include receiving a response from the psychiatric patient related to the psychiatric patient's goals.

Generating the report can include generating the report prior to an appointment with a physician. The questions that are phrased from the point of view of the psychiatric patient can be phrased in first person singular. The method can also include generating a report including a graph of historical recovery data. The graph of historical recovery data can be a graph of the psychiatric patient's recovery progress as related to the use of one or more prescription medications. The graph of historical data can be a graph of the psychiatric patient's recovery progress as related to the use of drugs or alcohol.

According to an aspect of the present invention, a method for use in treating a psychiatric disorder can include generating a question about a psychiatric patient's performance of a non-pharmacological activity used to assist the psychiatric patient in recovery. The method can also include receiving a first response that includes indication of the extent to which the psychiatric patient has performed the activity and generating a statement of a shared decision. The shared decision can be an activity to be performed by the psychiatric patient that was previously determined by the patient and doctor. The method can also include receiving a second response that includes an indication from the psychiatric patient regarding whether the psychiatric patient performed the shared decision. The method can also include generating a plurality of questions regarding the extent to which the patient encountered symptoms associated with the psychiatric disorder. The method can also include receiving a third response that includes an indication from the psychiatric patient of the extent to which the psychiatric patient encountered the symptoms. The method can also include generating one or more questions related to the psychiatric patient's use of prescribed medications. The method can also include receiving a fourth response that includes responses from the psychiatric patient regarding the use of the prescribed medications. The method can also include generating a report based on one or more of the first, second, third, and fourth responses. The method can also include generating one or more suggested interventions based on one or more of the first, second, third, and fourth responses.

Embodiments can include one or more of the following.

The method can include determining if the psychiatric patient used a particular medication as prescribed based on the response from the psychiatric patient. If the user did not use the particular medication as prescribed, the method can include generating a list of common concerns related to the user of the medication. The method can also include presenting the list of common concerns to the psychiatric patient on the user interface and receiving a response from the user, the response indicating the degree to which the patient has the concern. The questions can be phrased from the point of view of the psychiatric patient. The questions can be phrased in first person singular. The method can also include generating a report including a graph of historical recovery data.

According to an aspect of the present invention, a method for use in treating a psychiatric disorder includes retrieving information about a psychiatric patient from a database, the information including information about prescribed medications and information about a non-pharmacological activity used to assist the psychiatric patient in recovery. The method also includes generating, by a computer, a user interface, the user interface including a plurality of questions based on the retrieved information about the psychiatric patient, the questions being phrased from the point of view of the psychiatric patient. The method also includes displaying the user interface on a display device and receiving responses from the psychiatric patient to the plurality of questions. The method also includes storing the responses in a memory included in the computer and generating a report based on the responses.

Embodiments can include one or more of the following.

Generating the plurality of questions in the user interface can include generating a question about the psychiatric patient's performance of the non-pharmacological activity used to assist the psychiatric patient in recovery and generating one or more questions related to the use of prescribed medications. Receiving responses from the psychiatric patient can include receiving an indication of the extent to which the psychiatric patient has performed the activity and receiving responses from the psychiatric patient regarding the use of the prescribed medications.

The method can also include retrieving information about a shared decision from the database, the shared decision being an activity to be performed by the psychiatric patient that was previously determined by the patient and doctor. Generating the plurality of questions in the user interface can include generating a statement of a shared decision. Receiving responses from the psychiatric patient can include receiving an indication from the psychiatric patient regarding whether the psychiatric patient performed the shared decision.

The questions can be phrased in first person singular.

According to an aspect of the present invention, a method for use in treating a long-term disorder can include generating by a computer a user interface, the user interface including a plurality of questions phrased from the point of view of a patient. The method can also include displaying the user interface on a display device, receiving responses from the patient to the plurality of questions, and generating a report based on the responses.

### BRIEF DESCRIPTION OF THE DRAWINGS

FIG. 1 is a block diagram of a treatment plan generation process.

FIG. 2 is a block diagram of a treatment plan and individuals providing inputs into the treatment plan.

FIG. 3 is a flow chart of a process for generating a treatment plan.

FIG. 4 is a flow chart of a recovery information presentation process.

FIGS. 5A and 5B are diagrams of recovery information user interfaces.

FIG. 6 is a flow chart of a personal medicine and shared decision making process.

FIG. 7 is a diagram of a user interface related to use of personal medicine.

FIG. 8 is a diagram of a user interface related to personal medicine.

FIG. 9 is a diagram of a user interface related to a shared decision.

FIG. 10 is a flow chart of a process to collect data related to a patient's well being.

FIG. 11 is a diagram of a user interface for receiving input related to fulfillment of responsibilities.

FIG. 12 is a diagram of a user interface for receiving input related to the patient's physical health.

FIG. 13 is a diagram of a user interface for receiving input related to the patient's living conditions.

FIG. 14 is a diagram of a user interface for receiving input related to the patient's use of alcohol or drugs.

FIG. 15A is a flow chart of a process for gathering information related to the patient's use of medications.

FIG. 15B is a flow chart of a process for gathering information about concerns of a patient related to the patient's use of medications.

FIG. 16 is a diagram of a user interface related to a patient's use of medications.

FIG. 17 is a diagram of a user interface related to common concerns about medicine.

FIG. 18 is a diagram of a user interface about concerns related to use of medications.

FIG. 19 is a diagram of a user interface about concerns related to the use of medications.

FIG. 20 is a flow chart of a process to generate treatment options based on a patient's concerns.

FIG. 21 is a diagram of a report that includes possible interventions.

FIG. 22 is a diagram of a report that includes possible interventions.

FIG. 23 is a flow chart of a goal selection process.

FIG. 24 is a diagram of a user interface related to the patient's goals.

FIG. 25 is a diagram of a report.

FIG. 26 is a diagram of a report.

FIG. 27 is a diagram of a computer system.

### DETAILED DESCRIPTION

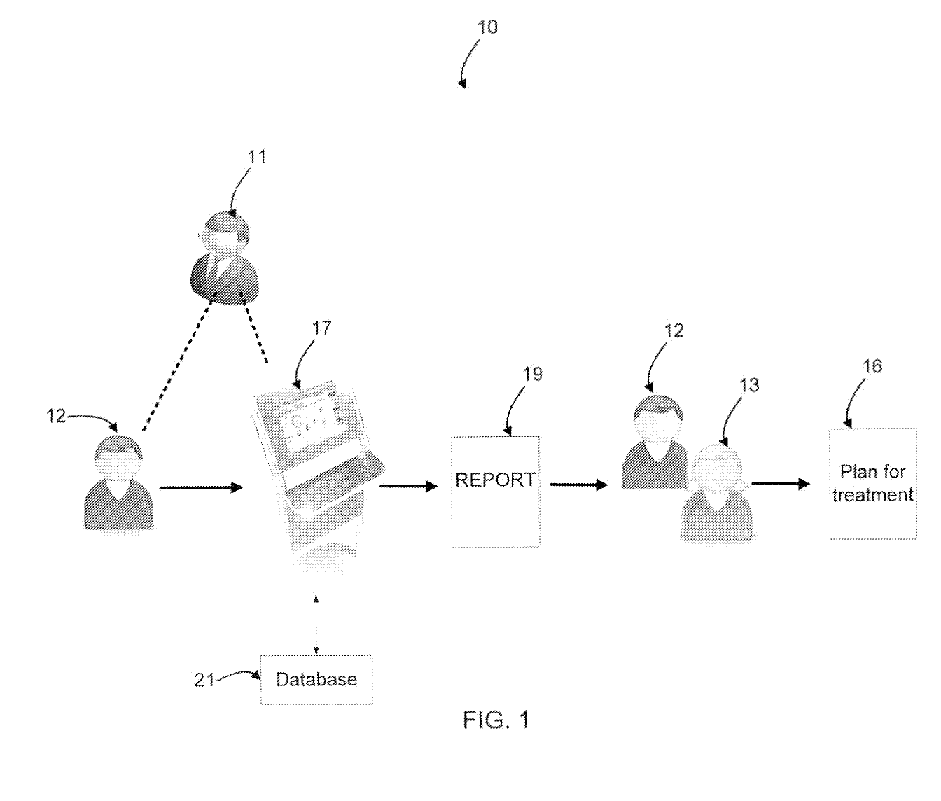

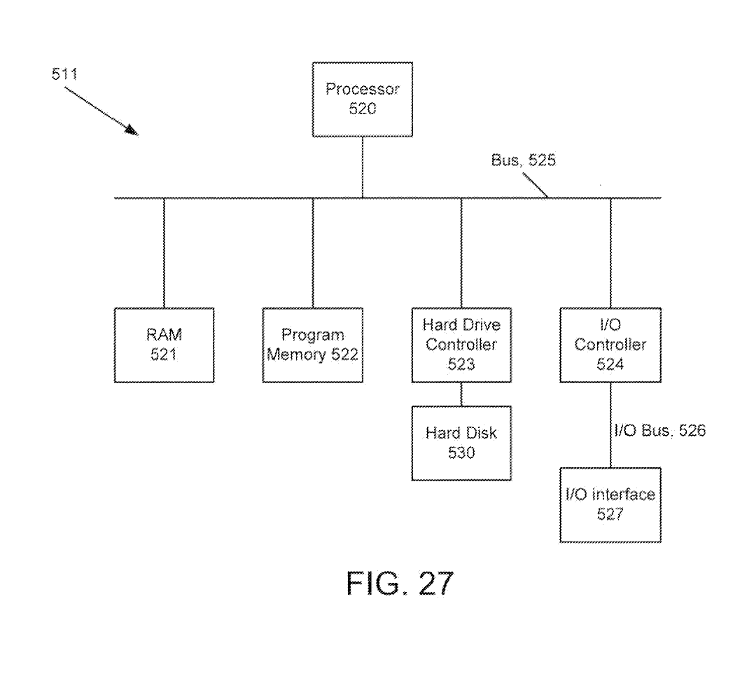

Referring now to FIG. 1, a system 10 that allows a patient, e.g., a psychiatric patient 12 to become involved in generation of and participate in “a treatment plan” 16 along with a doctor 13 and a case manager 15 is shown. Psychiatric disorders can include but are not limited to depression, schizophrenia, bipolar disorder and so forth. Prior to meeting with the doctor 13, the psychiatric patient 12 enters information about his/her current wellness and about various aspects of his/her recovery into a kiosk 17 or other computer-based device. An example of the general features of such a computer based device is described below in conjunction with FIG. 27. The information entered by the psychiatric patient 12 is stored in a database 21 and is used to generate a report 19 that conveys the patient's view of the patient's current recovery status, use of medications, and decisional uncertainty about using prescribed medicines or other concerns the patient may have. The doctor 13 and the psychiatric patient 12 discuss the report 19 together and, in collaboration, generate the treatment plan 16 for the psychiatric patient 12.

Other types of patients with different types of disorders can be assisted by the system including those that suffer from diabetes, hypertension, asthma, HIV/AIDS, and arthritis. Variations of the system 10 can be used in treatment of patients with other types of disorders.

In the example of a patient with a psychiatric disorder, the kiosk 17 can be located in a Peer Run Decision Support Center (DSC). The DSC is similar to the waiting area of the psychiatric medication clinic. However, in contrast to the waiting area of the psychiatric medication clinic, the DSC is staffed by people with psychiatric disorders who have recovered. When patients 12 arrive at the DSC for their appointment with their doctor 13, they are greeted by the peer specialists 11. The peer specialists 11 offer food and beverage and introduce the software program to the patients and support patients' use of the program.

The peer specialists 11 assist patients 12 with obtaining health related information from the Internet (for example an FDA fact sheet about medication effects and side effects). The peer specialists also assist patients with learning self-care and non-pharmacological coping strategies e.g., how to diminish auditory hallucinations through the use of headphones or subvocalization.

The peer specialists run peer-to-peer workshops where patients can come and learn how to effectively participate in shared decision making from other patients. Peer specialists 11 may assist patients 12 in identifying personal medicine and producing power statements (as described below), and they can use a keyboard to enter this information into the individualized patient survey. Peer specialists 11 can assist the patient 12 with implementing the intervention chosen by the doctor 13 and patient 12. For example, if the intervention was to complete a mood chart to track effectiveness of a medication during a medicine trial, the peer specialist 11 might help the patient 12 learn to use the mood chart after the appointment.

The peer specialist 11 can also follow up with the patient 12 after the appointment. For example, if the intervention was to complete a decisional balance worksheet, the peer specialist 11 might assist the patient 12 by contrasting subjective benefits of using a medicine against risks of using the medicine. If the intervention was to keep a daily diary of medication effectiveness, the peer specialist 11 might arrange for the patient 12 to call the Decision Support Center on a daily basis to make the diary entry. If the intervention was to explore an increase in personal medicine, then the peer specialist 11 would complete these forms with the patient 12, modify the power statement and enter the new data, in the patient's individual survey. If the intervention was to learn coping skills to manage panic, the peer specialist 11 would teach the patient 12 deep breathing techniques.

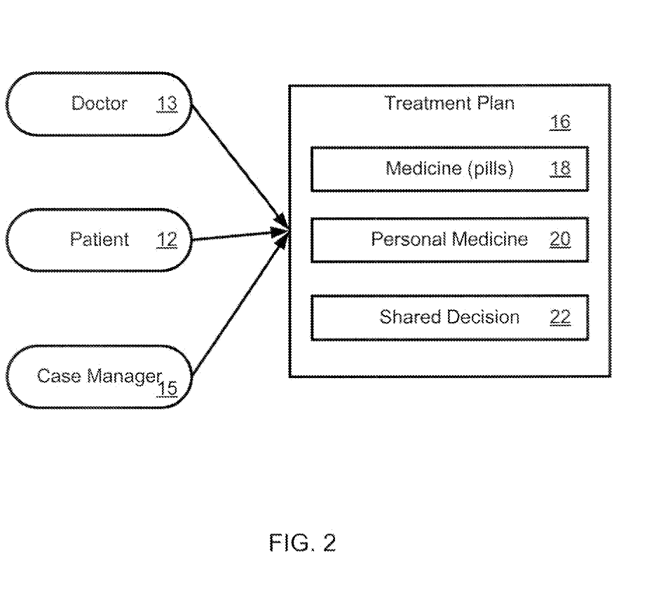

Referring now to FIG. 2, the various individuals are shown involved in a shared decision making process used to generate the treatment plan 16 for the patient A doctor 13, psychiatric patient 12, and case manager 15 (which in some instances could be the doctor or may be optional) work together to select treatment options that are included in the treatment plan 16 used to treat the psychiatric patient 12.

This computer assisted process involves “shared decision making” that relies on including the psychiatric patient 12 in entering decisions/answers to questions regarding that patient's treatment. The questions are preferably phrased from the point of view of the patient, as discussed below. By explicitly including the patient 12 in the decision making process, this explicit inclusion can increase the likelihood that the patient will follow the prescribed treatment plan 16. Following the treatment plan can result in increased wellness for the psychiatric patient 12.

The treatment plan 16 can include pill-based (e.g., prescription) medicines 18, “personal medicines 20,” and/or “shared decisions” 22. The pill-based medicines 18 are chemical-based medications prescribed by the doctor to help treat the patient's disorder or to help treat symptoms of the patient's disorder. While pill-based medicines 18 can be an important aspect in the patient's recovery, other types of treatments such as the personal medicines 20 can also be used.

“Personal medicines 20” are non-pill based devices and activities that assist the psychiatric patient 12 in his/her recovery. Personal medicines are not a collection of over the counter drugs, prescription drugs, and herbal remedies. Rather personal medicines 20 are activities that the patient 12 performs to aid in recovery. For example, a personal medicine 20 can be something that makes the psychiatric patient 12 feel good about himself/herself, makes the psychiatric patient 12 feel wanted, and/or helps the psychiatric patient 12 to raise his/her self-esteem. In general, personal medicines 20 are activities that give the psychiatric patient 12 purpose and meaning. Personal medicines 20 will vary from patient to patient because of the manner in which different patients cope with distress and participate in the community differ.

Examples of personal medicines include parenting, singing in a choir, helping others, volunteering, exercising, eating a healthy diet, going to school, going to work, participating in a peer support group, caring for a pet, going to church, and walking. Other personal medicines include maintaining important friendships, participating in a hobby, reading, praying, gardening and homemaking.

The patient 12 and the doctor 13 can determine the personal medicines to be used by the patient 12. The personal medicines may change during different times in the patient's recovery. For example, the patient 12 and doctor 13 can select personal medicines by discussing activities that enhance wellness and self esteem or that give meaning and purpose to life. For example, the doctor may ask the patient to photograph the things that make life worthwhile and the patient might discuss these photographs with the doctor in an effort to identify personal medicine. Additionally, the doctor may explore and suggest coping strategies that will help to reduce unwanted symptoms and help manage the illness. An example is that the patient may love music. The doctor might suggest listening to music via headphones to decrease auditory hallucinations.

The treatment plan 16 also includes one or more shared decisions 22. A shared decision 22 is produced by both the patient 12 and doctor 13 and defines the next steps in the ongoing treatment process. The shared decision 22 is generated by the doctor 13 and the psychiatric patient 12 discussing the patient's current recovery process and together determining one or more tasks or activities for the psychiatric patient 12 to focus on that may help to improve the patient's wellness and recovery. Examples of shared decisions can include an agreement to continue with a medication at a lower dosage while increasing daily exercise; beginning a new medication for bipolar disorder while using a mood diary to track the effectiveness of the medication over time; and addressing decisional uncertainty about using a medication by completing a decisional balance sheet so as to weight the pros and cons, benefits and risks of the treatment with consideration for overall quality of life (personal medicine) concerns.

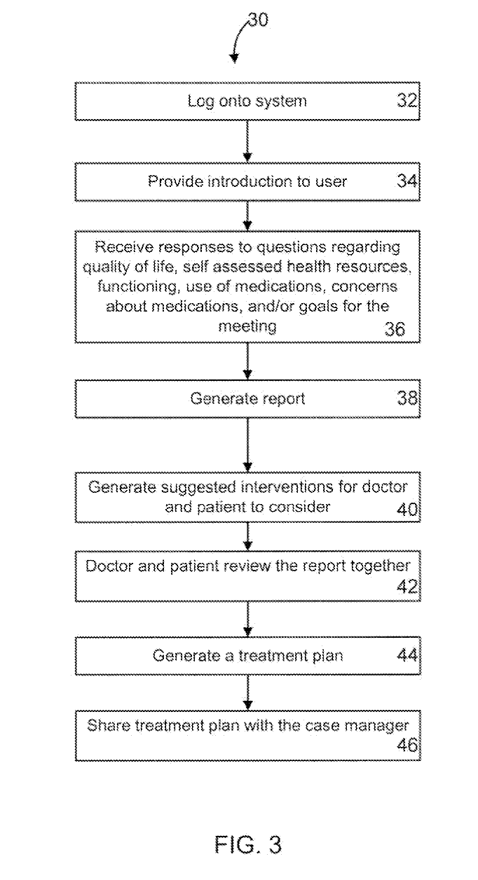

Referring now to FIG. 3, the treatment plan generation process is centered on the psychiatric patient's involvement in providing information and actively participating in generating the treatment plan 16 and activity monitoring the patient's own progress on the treatment plan 16.

In order to allow the psychiatric patient 12 to provide information, the psychiatric patient 12 logs 32 onto a computerized system. The system includes a database 21 that stores information about the patient 12 such as the patient's treatment history, previously generated treatment plans, and/or notes or other information related to the patient's recovery. The system provides 34 an introduction to the psychiatric patient 12 that explains how the system works and the importance of providing an accurate assessment of the patient's recovery.

The system generates 36 questions and receives responses from the psychiatric patient 12 to questions regarding the patient's quality of life, self assessed health resources, functioning, use of medications, concerns about medications, and/or goals for the patient's appointment with his/her doctor. The system summarizes 38 the patient's responses and generates a report. The system also generates 40 one or more suggested interventions for the doctor 13 and psychiatric patient 12 to consider. The suggested interventions can include recovery tools or activities that are provided to reduce the patient's decisional uncertainty with regard to the treatment plan. The doctor and the psychiatric patient 12 review 42 the report together. Reviewing the report together can enable the doctor 13 and the psychiatric patient 12 to focus their discussion and attention during the patient's appointment on items that are of the greatest concern to the patient 12. After the doctor 13 and the psychiatric patient 12 have reviewed the report; together they generate 44 a treatment plan 16. This treatment plan 16 can be shared 46 (e.g., e-mailed, faxed, etc.) to others involved in treatment of the patient's disorder such as a case manager or a support group.

Recovery Information

In order for a patient 12 to assess his/her progress, it is important for the patient to understand what recovery is and believe that recovery is possible. In general, recovery from a psychiatric disorder does not necessarily mean that all symptoms of the disorder will be abated; however, recovery does mean that the psychiatric patient 12 finds mechanisms to cope with some or all of the symptoms to enable the psychiatric patient 12 to actively participate in the community. In addition, recovery is an active process and is not the same as maintenance. Recovery encompasses more than just staying out of the hospital or institution. Recovery means achieving a life similar to others in the community; living, working and fulfilling responsibilities in integrated settings while participating the cultural and economic life of the community. It means finding a life and identity beyond that of the diagnosis. Concretely it can mean being employed, being a parent, being a homemaker, going back to school, pursuing avocations and hobbies, and/or finally, making a contribution to the community. It includes actively building relationships with others and participating in activities that assist in wellness.

In order for a patient to participate effectively in determining a treatment plan 16 with his/her doctor 13, the patient 12 should understand the recovery process and understand that recovery is possible.

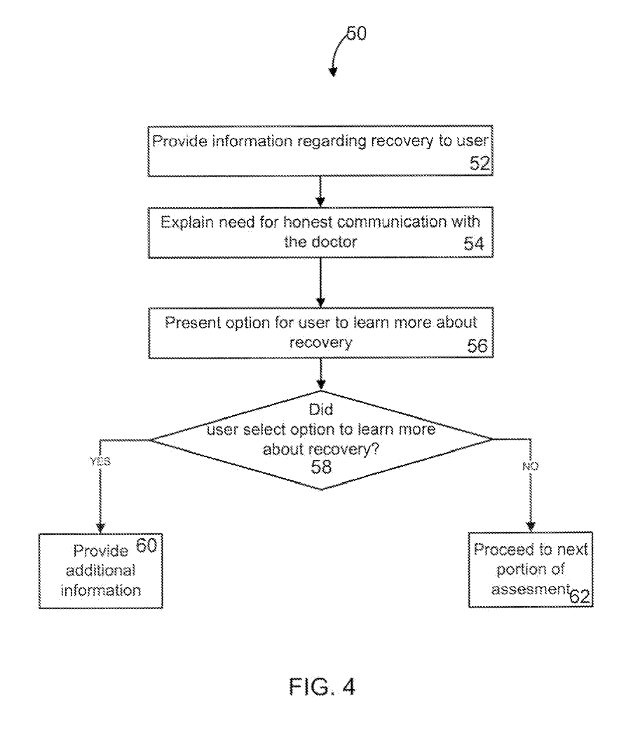

Referring now to FIG. 4, a process 50 for presenting information on recovery to a psychiatric patient 12 is shown. Process 50 includes providing 52 information to the psychiatric patient 12 about recovery.

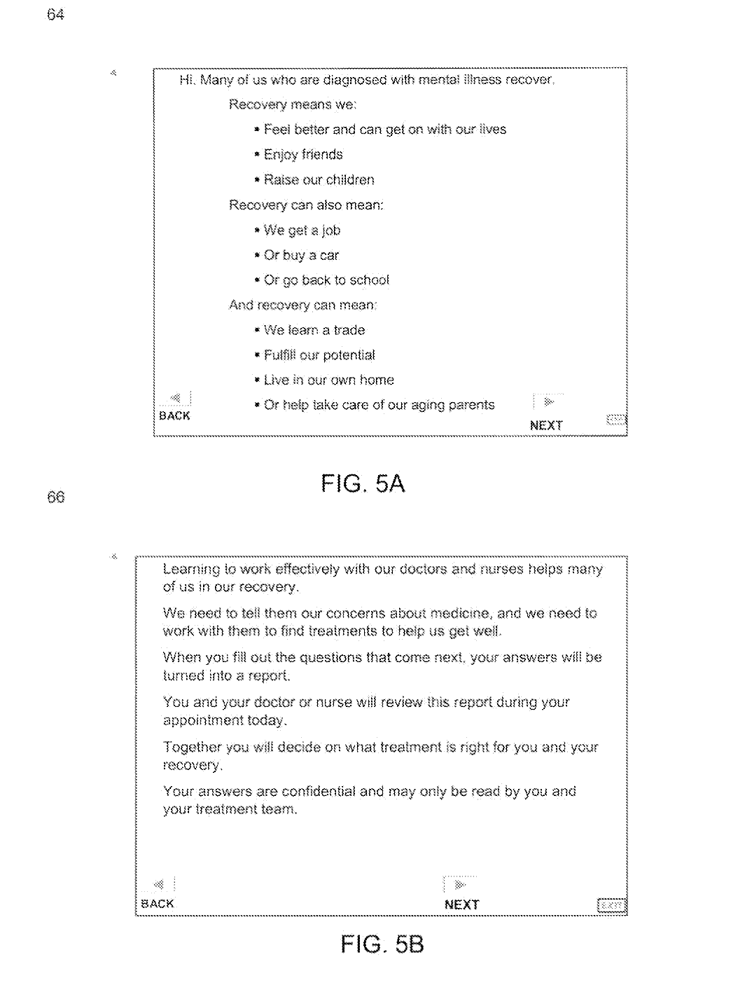

FIG. 5A shows an exemplary screenshot 64 that provides examples of how information on what recovery can include is conveyed to the patient 12. The system also provides information to the psychiatric patient 12 explaining that honest communication between the psychiatric patient 12 and doctor 13 is essential for the recovery process (54).

FIG. 5B shows an exemplary screenshot 66 that provides the psychiatric patient 12 with information about the importance of the information he/she provides about his/her recovery and how the information will be used by the doctor 13 to aid in his/her recovery.

Referring back to FIG. 4, the system presents 56 an option for the psychiatric patient 12 to learn more about recovery and determines 58 whether the psychiatric patient 12 has selected to receive additional information. If the psychiatric patient 12 did not select to receive additional information about the recovery process, the system gathers 62 information about the patient's recovery.

On the other hand, if the psychiatric patient 12 selects to receive additional information about recovery, the system presents 60 additional information to the psychiatric patient 12. For example, the system can provide videos of others describing their recovery process that the patient can view and/or the system can present additional written information about recovery that the patient can read.

Power Statement, Personal Medicine and Shared Decision

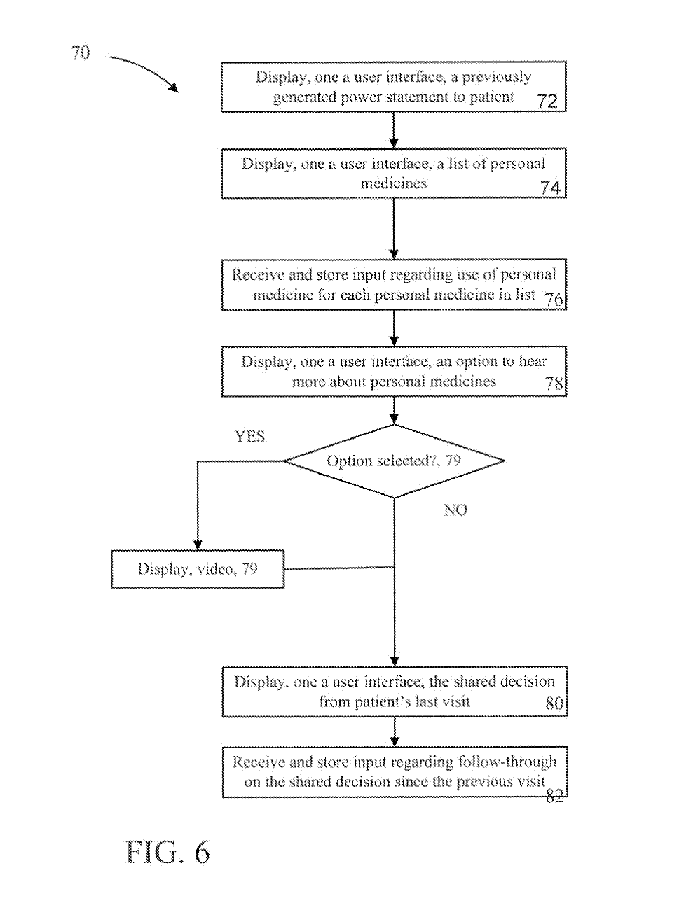

Referring now to FIG. 6, a process 70 for presenting information to a psychiatric patient 12 and receiving input from the psychiatric patient 12 related to the patient's power statement, personal medicine(s), and shared decision(s) is shown. Process 70 includes displaying 72 on a user interface a previously generated power statement to a patient. A “power statement” is a patient's goal for using medication to support his/her recovery. The doctor and the psychiatric patient 12 generate the power statement together, and the system stores that patient's power statement in the system database 21 so that it can subsequently be retrieved and presented to the patient 12. Generating a power statement and presenting the power statement to the patient during the patient's doctor appointments can be beneficial because it is the patient's invitation to the doctor 13 to participate collaboratively in the shared treatment decision making process. The power statement captures the overarching reason or purpose of engaging in treatment at all. It directs the doctor to collaborate with the patient 12 in finding holistic treatments that address, not lust symptoms, but overarching concerns about quality of life. Power statements represent the patients understanding that sometimes treatments can be disabling. The power statement invites the doctor 13 to collaborate with the patient 12 to find treatments that enable, rather than disable.

An example of a power statement is:
Being a good mother to my child is powerful personal medicine and is vital to my recovery. I don't want medication side effects such as sedation, or my symptoms of depression, to interfere with my ability to be a good mom. You and I must work together to find a medication that supports my being a good mom, so that being a good mom can support my recovery.

As described above in relation to FIG. 1, a patient's treatment plan 16 includes one or more personal medicines 20 that are non-drug based activities that assist in the patient's recovery. Process 70 displays 74 a list of the patient's personal medicines 20 to the psychiatric patient 12 on a user interface and receives 76 inputs from the psychiatric patient 12 regarding his/her use of each personal medicine in the list of personal medicines. The inputs about the patient's use of his/her personal medicine are stored in the system's database 21.

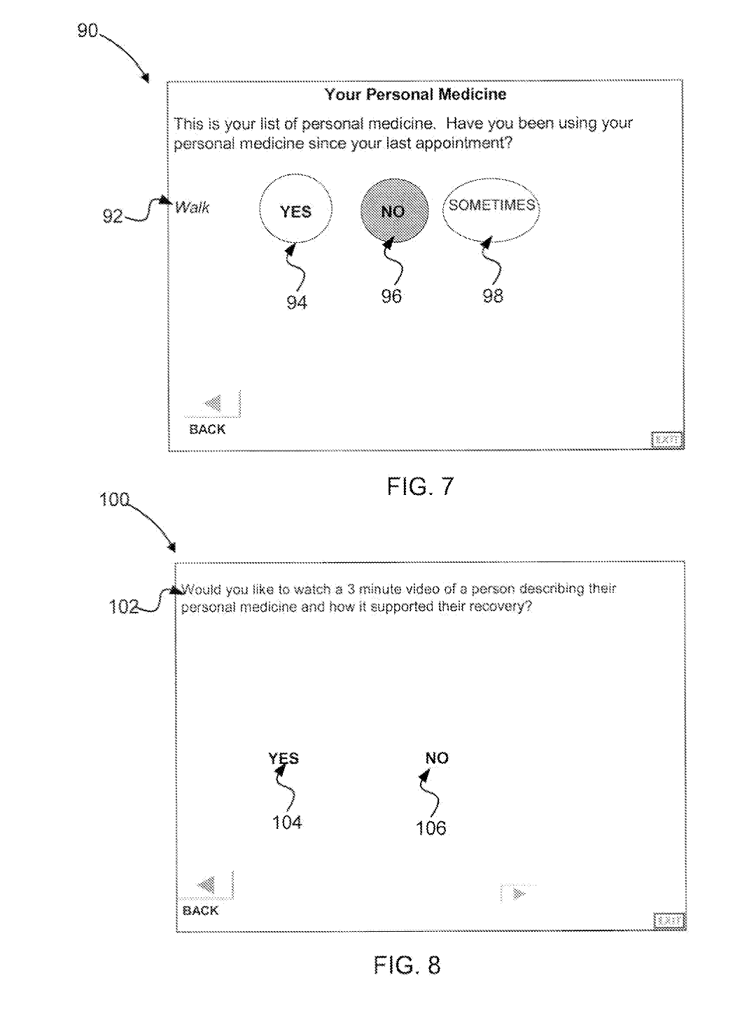

Referring now to FIG. 7, an exemplary user interface 90 for collecting information about the patient's use of his/her personal medicine includes a list of personal medicines 92. In this example, the patient's list of personal medicines 92 includes only one personal medicine, “walking.” The user interface 90 includes buttons 94, 96, and 98 (here color-coded to indicate positive, neutral and negative answers much like a traffic light) that the psychiatric patient 12 selects to indicate whether he/she have been using his/her personal medicine.

Referring back to FIG. 5, after the psychiatric patient 12 has entered information about his/her use of the personal medicines, the system presents 78 the psychiatric patient 12 with the option to receive additional information about personal medicines. For example, as shown in FIG. 8, the system displays 79 a user interface 100 that presents the psychiatric patient 12 with the option to watch a short video of another person describing his/her personal medicine and how it aided in recovery. The psychiatric patient 12 can select whether to watch the video by pressing the desired selection button 104 or 106.

Process 70 also includes presenting, on the user interface, the patient's shared decision (80) and receiving input regarding the patient's follow-through with the shared decision (82). As described above, a shared decision is a plan or action item generated by the patient 12 in collaboration with the doctor 13 or case manager that can assist in the patient's recovery.

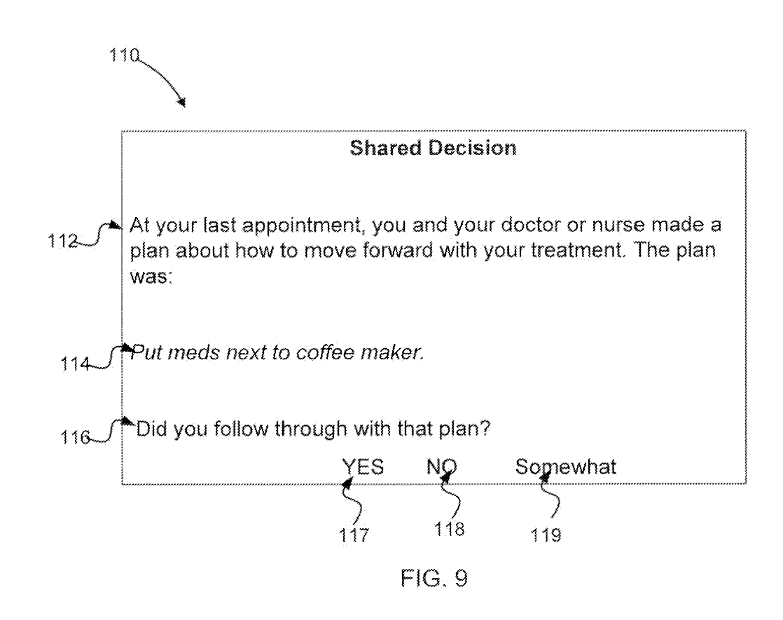

FIG. 9 shows an exemplary user interface 110 for receiving information about the patient's use of his/her shared decision. The user interface 110 includes a statement 112 reminding the psychiatric patient 12 of his/her involvement in generating the shared decision, a listing 114 of the shared decision, and multiple input buttons 117, 118, and 119 for the psychiatric patient 12 to indicate to what extent he/she followed through with implementing the shared decision.

Reminding the psychiatric patient 12 of his/her power statement, shared decision, and personal medicines can aid in the patient's recovery by increasing the patient's accountability in implementing the determined course of action. In addition, since the patient 12 has helped to generate each of these items, the patient 12 may have more motivation to try to meet the goals set out by the personal medicines and shared decisions. The power statement, personal medicines and shared decisions are written in the patients own words in order to underscore patients' active collaboration in the shared treatment decision making process. This personalized voice helps to bridge the chasm between generic treatment recommendations and individual patients, thereby framing ongoing treatment for a long-term disorder in the context of patients' lives. Indeed, unlike acute illnesses where treatment procedures are undertaken in clinical settings, treatment for long-term disorder takes place in the context of patients' everyday lives. The power statement, shared decision and personal medicine help to link what happens in the psychiatric consultation, to everyday life where treatment decisions must be carried out by the patient.

Patient's Self-Assessment

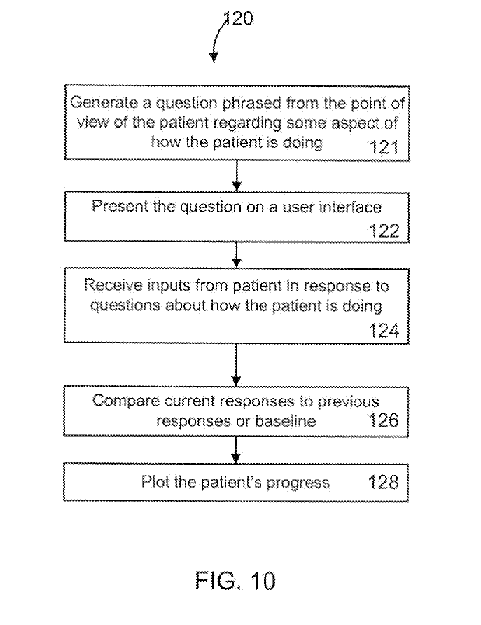

FIG. 10 shows a process 120 for determining and plotting a patient's recovery progress. Process 120 includes generating 121 a question about some aspect of how the patient regards the status of various aspects of his/her well-being.

In the questions that are posed to the patient, the questions are preferably phrased in the first person singular, that is, posed from the point of view of the patient. By phrasing questions from the point of view of the patient (e.g., in first person singular), it is believed that such phrasing helps the patient 12 to provide a more accurate assessment of his/her well-being. In addition, responses are also phrased from the point of view of the patient, again first person singular which also assists in helping the patient 12 provide a more accurate assessment.

More particularly, questions are phrased from the patient's point of view in order to minimize medical and/or psychiatric language which can be stigmatizing. The everyday quality of the language is intentional and helps to level the playing field between the doctor and patient which is consistent with the goal of laying the framework to help both parties arrive at a shared treatment decision. The questions generated by the system are presented to the patient on a user interface (122). The patient reads and responds to the questions and the system receives and stores the responses from the patient (124).

In order to generate historical data about the patient's recovery, the system compares 126 the current responses to each of the questions to previous responses or to a baseline and plots 128 a historical graph of the patient's recovery progress.

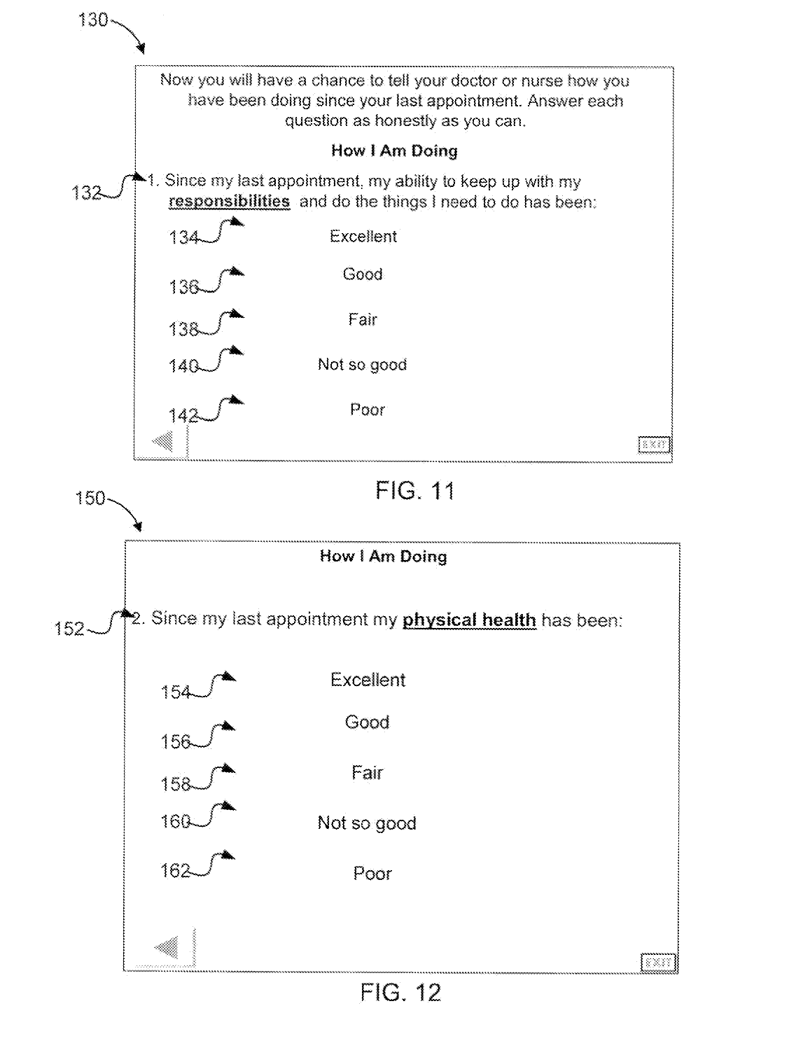

FIGS. 11-14 show exemplary user interfaces 130, 150, 170 and 180 generated by the system to collect information from the patient 12 about the patient's well-being. As described in more detail below, each of the user interfaces 130, 150, 170 and 180 includes a statement of an activity or a condition phrased from the patient's point-of-view and a set of potential responses.

Referring to FIG. 11, a user interface 130 for receiving input from the patient about his/her ability to perform his/her responsibilities includes a statement 132 about an aspect of the patient's wellbeing, namely:
“Since my last appointment, my ability to keep up with my responsibilities and do the things I need to do has been:”

The user interface 130 also includes controls 134, 136, 138, 140, and 142, which the psychiatric patient 12 selects, to indicate that his/her ability to perform the responsibilities has been excellent, good, fair, not so good, or poor, respectively.

Referring to FIG. 12, a user interface 150 for receiving input from the psychiatric patient 12 about his/her physical health includes a statement 150 about the patient's physical health, namely:
“Since my last appointment my physical health has been:”

The user interface 150 also includes buttons 154, 156, 158, 160, and 162 which the psychiatric patient 12 can select to indicate that his/her physical health has been excellent, good, fair, not so good, or poor, respectively.

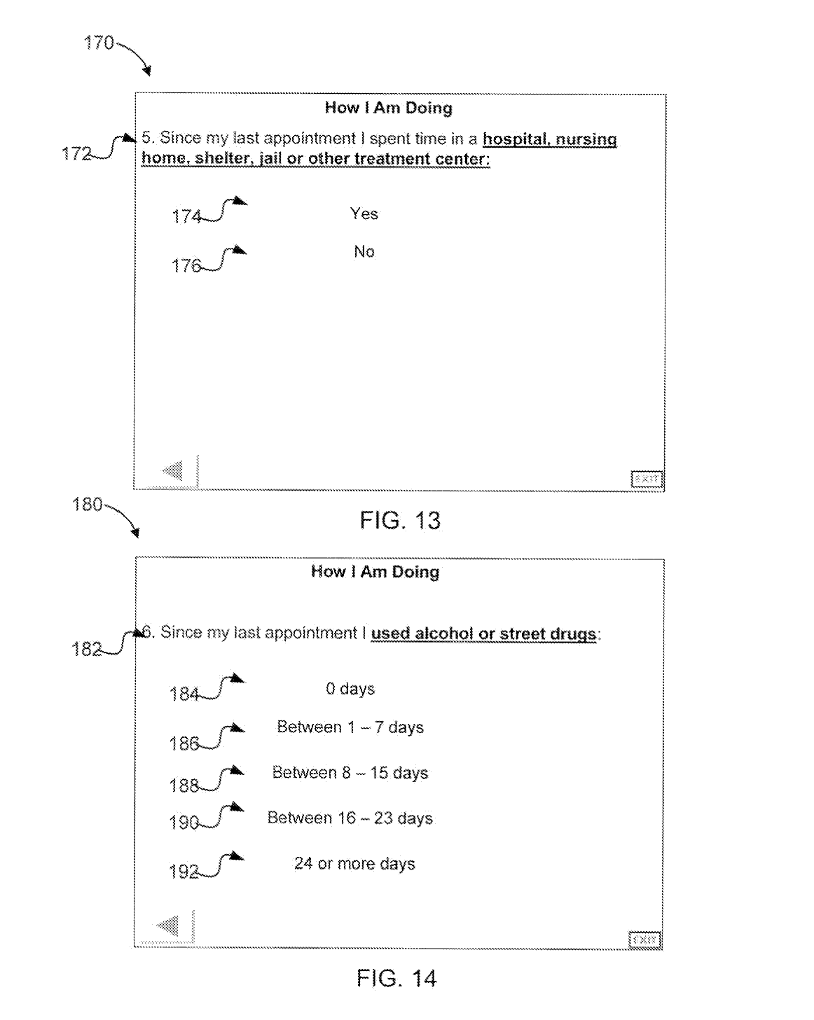

Referring to FIG. 13 a user interface 170 for receiving input from the psychiatric patient 12 about whether he/she has spent time in a facility such as a hospital, nursing home, shelter, jail, or treatment facility includes a statement 172 about the patient's living situation phrased from the point-of-view of the patient, namely:
“Since my last appointment I spent time in a hospital, nursing home, shelter, jail or other treatment center:”

The user interface 170 also includes buttons 174 and 176 which the psychiatric patient 12 can select to indicate that he/she has or has not spent time in such a facility since the last appointment.

Referring to FIG. 14, a user interface 180 for receiving input from the psychiatric patient 12 about his/her use of alcohol or street drugs includes a statement 182 about the patient's use of such drugs phrased from the patient's point-of-view, namely:
“Since my last appointment I used alcohol or street drugs:”

The user interface 180 also includes buttons 184, 186, 188, 190, and 192 which the psychiatric patient 12 can select to indicate he/she has used such drugs for, e.g., 0 days, 1-7 days, 8-15 days, 16-23 days, or more than 24 days, respectively.

While FIGS. 11-14 show exemplary questions and exemplary responses used to generate information about the patient's wellbeing other questions can be used to assess other aspects of how the patient is doing. Such questions can focus on areas including physical health, mental health, living situation, ability to perform various activities, fulfill responsibilities, and overall recovery. In addition, patients are asked to report on their experience of auditory hallucinations, mood/energy, sleep, concentration, anxiety, homicidal ideation, suicidal ideation, disordered thinking and flight of ideas. Some exemplary questions and allowable responses are presented below:
Since my last appointment my overall mental health has been:
   Excellent
   Good
   Fair
   Not so good
   Poor
Since my last appointment my living situation has been:
   Excellent
   Good
   Fair
   Not so good
   Poor
Since my last appointment I heard voices or saw things that others didn't:
   None of the time
   A little of the time
   Some of the time
   Most of the time
   All of the time
Since my last appointment my energy level was too low:
   None of the time
   A little of the time
   Some of the time
   Most of the time
   All of the time
Since my last appointment my energy level was too high:
   None of the time
   A little of the time
   Some of the time
   Most of the time
   All of the time
Since my last appointment I have experienced thoughts, beliefs or fears that bothered me:
   None of the time
   A little of the time
   Some of the time
   Most of the time
   All of the time
Since my last appointment I was able to concentrate and pay attention to the things I need to do:
   None of the time
   A little of the time
   Some of the time
   Most of the time
   All of the time
Since my last appointment my thoughts were racing through my mind and going too fast:
   None of the time
   A little of the time
   Some of the time
   Most of the time
   All of the time
Since my last appointment I felt nervous or anxious:
   None of the time
   A little of the time
   Some of the time
   Most of the time
   All of the time
Since my last appointment my sleep was just right:
   None of the time
   A little of the time
   Some of the time
   Most of the time
   All of the time
Since my last appointment I have had thoughts about hurting others:
   None of the time
   A little of the time
   Some of the time
   Most of the time
   All of the time
Since my last appointment I have had thoughts about hurting myself:
   None of the time
   A little of the time
   Some of the time
   Most of the time
   All of the time
In general, the phrase which describes my recovery from mental illness at this time is:
   I have recovered
   I am getting better
   I am the same
   I am getting worse
   I am the worst I've ever been

The exemplary questions listed above can be modified by the doctor 13 and patient 12 to reflect the unique concerns of the patient 12. Modifications can be made through an editing utility program at the doctor's computer interface. Modifications can be made in three ways. Questions that are not relevant to the patient can be deleted altogether. For example, questions about energy level may not be relevant to patients with phobias and might be deleted. Secondly, the question can be re-phrased to be acceptable to a patient. For example, a patient may insist that he/she does not hear voices but rather hears the FBI wire-tapping him. The question could be modified from, “Since my last appointment I heard voices that others could not hear” to “Since my last appointment I have been hearing the FBI wire-tapping me.” And the third modification is to customize the question to reflect known indicators for relapse. For example, doctor and patient may have learned that when sleep is less than 2 hours per night for 2 consecutive nights, the patient is at risk for a manic episode. The question might then read, “Since my last appointment I have slept less than 2 hours for 2 consecutive nights.”

Use of Prescribed Medications

In order for a doctor 13 to accurately assess whether a particular prescription medication or dosage of a medication is effective for a patient, the doctor 13 needs information regarding the actual usage of the medication by the psychiatric patient 12. There are many different reasons a psychiatric patient 12 may decide not to take a particular medication. In order to determine the right medication regiment for a particular psychiatric patient 12, the doctor 13 determines how the patient's body responds to particular medications and whether the patient 12 has concerns which may keep the patient 12 from taking the medication.

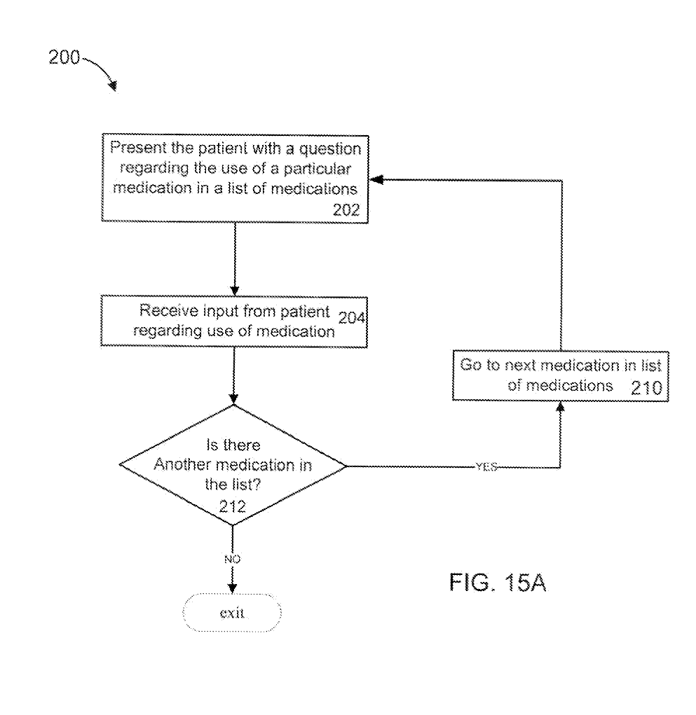

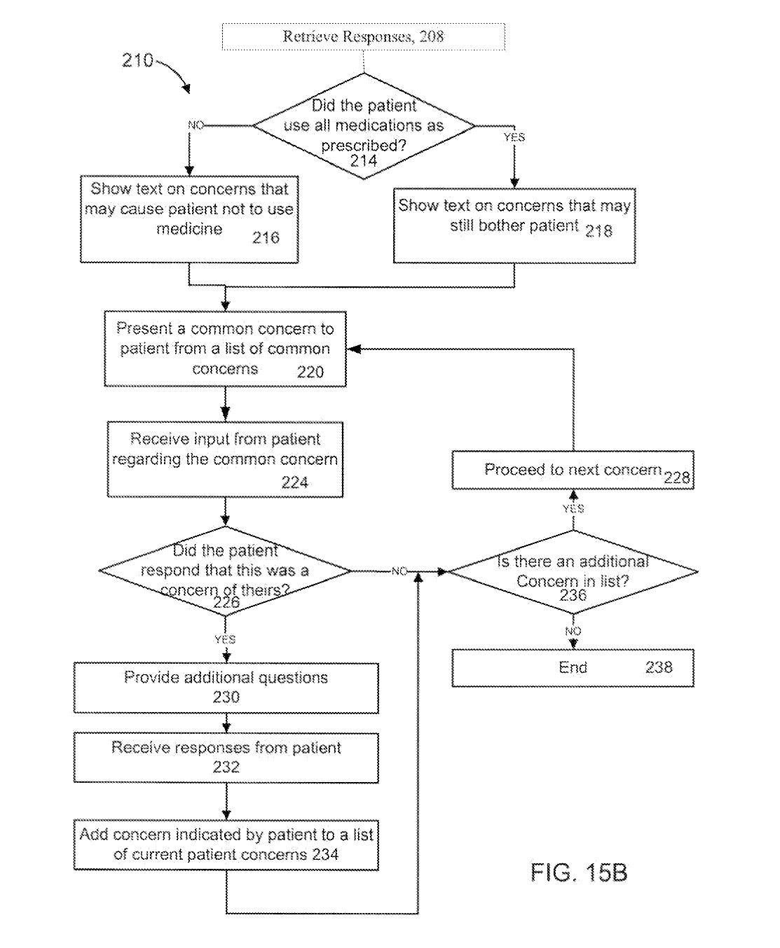

Referring now to FIG. 15A a process 200 for receiving input from a patient 12 about his/her use of prescribed medications includes presenting 202 the psychiatric patient 12 with a question regarding his/her use of a particular medication. The question is presented to the patient 12 on a user interface and the psychiatric patient 12 responds 204 by indicating the extent to which he/she used the medication as prescribed. From the response, the system determines 212 if there is another medication in the list of prescribed medications. If there is another prescribed medication, then the system proceeds to the next medication in the list (210) and presents questions and receives responses from the patient about his/her usage of the next medication (202 and 204). This collection process continues until the system has collected usage information on all of the patient's prescribed medications.

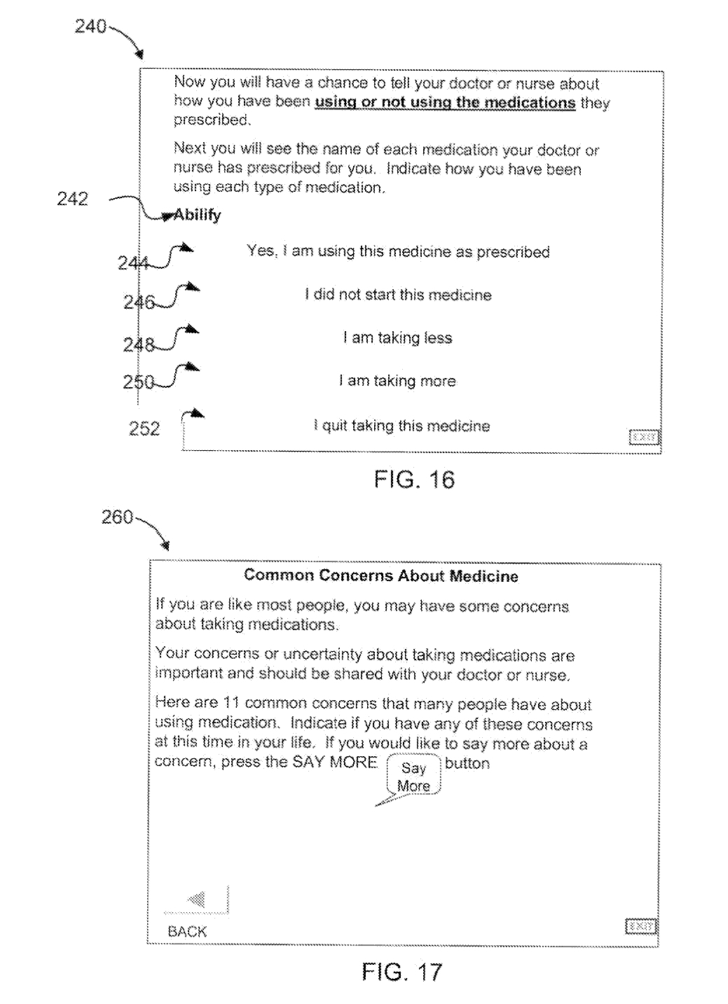

Referring now to FIG. 16 an exemplary user interface 240 for receiving information from the psychiatric patient 12 regarding his/her use of a drug prescribed by the doctor 13 is shown. The user interface 240 includes the name of a particular medication 242 prescribed to the psychiatric patient 12 and multiple options related to usage of the medicine by the patient 12. The usage statements are phrased from the point-of-view of the patient. It is believed that phrasing the usage inputs from the point-of-view of the patient can be beneficial because the responses reflect the range of real-world options for using or not using medications that most patients consider following a medical consultation. The presentation of a range of options conveys a non-judgmental approach provided to elicit honesty in reporting. The questions are phrased in a matter-of-fact, everyday way that reflects the choices that a patient has made about taking medicine. Phrasing these items from the patient's point of view also serves as a reminder that the patient is an important collaborator with the doctor and has an important role to play in arriving at a shared treatment decision.

Exemplary usage inputs include:
Yes, I am using this medicine as prescribed 244,
I did not start this medicine 246,
I am taking less 248,
I am taking more 250, and
I quit taking this medicine 252.

Referring now to FIG. 15B, processing 210 of psychiatric patient's usage of each prescribed medication is shown. Once the psychiatric patient 12 has provided input regarding his/her usage of each prescribed medication, the system determines 214 whether the psychiatric patient 12 used all of the medications, as they were prescribed. The system accesses a file that contains a listing of all of the prescribed medications and the manner in which they were prescribed and compares that data to the data provided by the psychiatric patient 12.

Regardless of whether the psychiatric patient 12 has been using the medications as prescribed, the psychiatric patient 12 may have concerns about the use of one or more medications. Concerns about medicine can lead to decisional uncertainty about using it or result in an unwillingness to use effective treatment. Left unattended, the concerns that lead to decisional uncertainty can lead to non-compliance and poor treatment outcomes. By addressing decisional uncertainty as it arises, the doctor and patient can proceed in a more efficient and effective manner with regards to shared treatment decision making. The concerns about the medicine usage may vary dependent on whether the patient has been using the medication. In order to address these differences in attitude toward the use of medications and the concerns that can be common to both those using the medication and those who are not, the system presents information about concerns to the psychiatric patient 12.

For example, if the process 210 determines 214 that the patient has not been using the medications as prescribed, the process 210 displays 216 a message, e.g., a brief portion of text indicating that it is normal to have concerns about the use of medications. On the other hand, if process 210 determines 214 that the psychiatric patient 12 has been using the medications as prescribed, the system can display 218 a message indicating that concerns about the use of medications may still exist even when the patient is using the medications.

FIG. 17 shows a user interface 260 that provides assurance to the psychiatric patient 12 that having concerns about taking medicines is normal and that sharing these concerns with the doctor 13 is beneficial.

Process 200 includes generating 220 and presenting, on the user interface, a common concern related to usage of a medicine from a list of common concerns that may be experienced by the patient. Exemplary common concerns include concerns about side effects, concerns that medicine is unhelpful, concerns about how the medicine interacts with drugs or alcohol, concerns about how the medicine is affecting health, concerns related to a lack of motivation to use medicine, beliefs and moral judgments about medicine, concerns related to a need for more support or information about medicine, concerns with being able to pay for medicine, fears related to past adverse reactions to medicine, confusion about when and how to take medicine, and concerns about whether medicine is really needed or if the disorder has been cured. Process 200 receives 224 input from the patient 12 regarding whether or not the concern applies to him/her. The system determines 226, based on the response, whether the patient indicated that the concern was a concern that they had. If the patient indicated 230 that the current concern was a concern of his/hers, the system provides more detailed questions related to the concern and receives 232 additional information from the patient 12 about why he/she is concerned about the particular item and records 234 the concerns and the additional information in a list a current patient concerns to be reviewed by the doctor 13.

If the patient 12 indicates (e.g., in response to 224) that a particular concern is not a concern or after the additional information has been received (e.g., in response to 234), the system determines 236 if there is an additional concern in the list of concerns. If so, the system proceeds to the next concern (228) and if not, the process 200 ends (238).

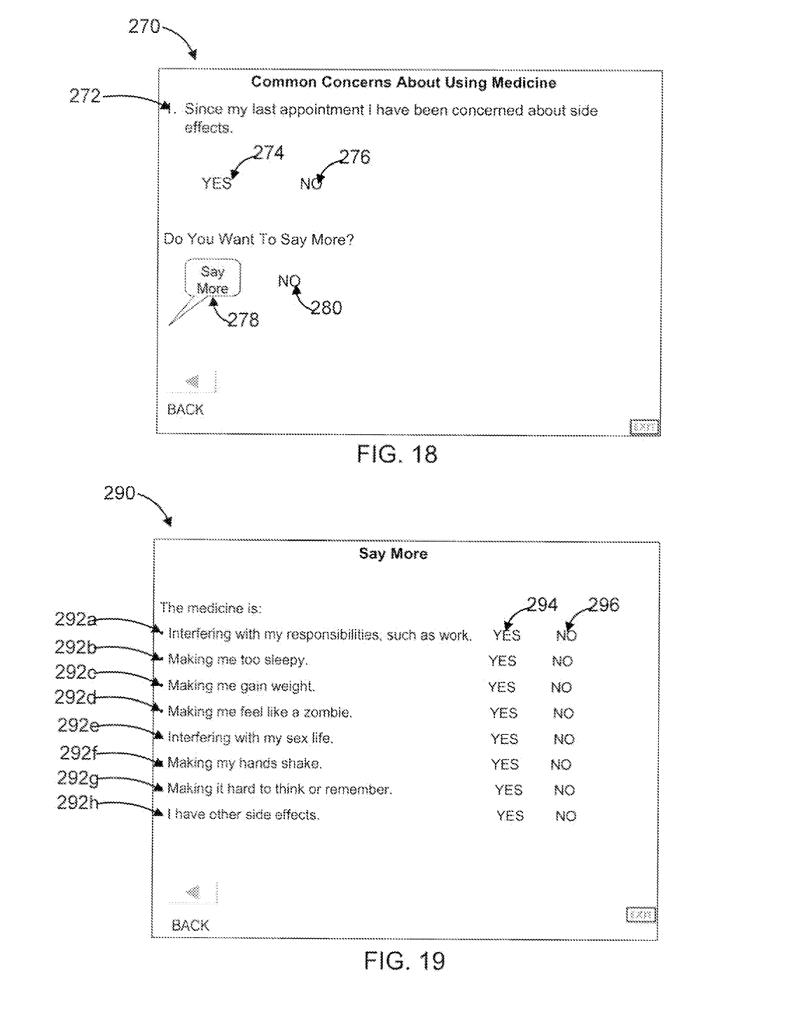

FIGS. 18 and 19 show user interfaces 270 and 290 for receiving input from the patient 12 about concerns he/she has about using the medications prescribed by the doctor 13.

FIG. 18 shows a user interface 270 that lists a common concern 272 that the psychiatric patient 12 may be experiencing, namely a concern about side effects. User interface 270 includes buttons 272 and 276 which the psychiatric patient 12 can select to indicate whether he/she is concerned with side effects from the medication(s). If the patient indicates that he/she is concerned about side effects, the psychiatric patient 12 can select to say more about such concerns by pressing button 278. If the patient selects to provide more information, user interface 290 (see FIG. 19) presents a list of concerns related to side effects 292a-h and allows the psychiatric patient 12 to indicate if the statement applies by selecting yes or no using buttons 294 and 296. Common concerns are written from the patient's point of view. This is intended to normalize the experience that the patient is having and to encourage patients to report decisional uncertainty about using prescribed medicine to the doctor.

Exemplary concerns and follow-up questions related to concerns that may keep a patient from taking his/her medications are presented below:
Since my last appointment I have been concerned about side effects.
   Interfering with my responsibilities, such as work.
   Making me too sleepy.
   Making me gain weight.
   Making me feel like a zombie.
   Interfering with my sex life.
   Making my hands shake.
   Making it hard to think or remember.
   I have other side effects.
At this time, the medicine doesn't seem to be working for me.
I have some concerns about medication and the alcohol or drugs I use.
   I'm concerned about getting addicted to the medicine.
   I'm concerned about how alcohol or drugs will interact with the medicine.
   If I know I am going to party, then I skip the medicine.
   I think drugs or alcohol work better for me than the medicine.
   When I am drinking or using drugs I forget to take the medicine.
   I have other concerns about the medicine and the drugs or alcohol I use.
I'm concerned about how the medicine is affecting my health.
   I'm concerned about getting diabetes on this medicine.
   I'm concerned about gaining weight on this medicine.
   I'm trying to get pregnant, or I am pregnant, and I'm concerned about how this medicine will affect me and my baby.
   I have concerns about getting tics or other movement disorders from this medicine.
   I have other concerns about how this medicine is affecting my health.
I'm not motivated to use the medicine at this time in my life.
   I haven't found a good reason to take medicine.
   I only take medicine because the judge or my family says I should.
   The pills remind me of mental illness, so I don't take them.
   I'm tired of taking pills.
   My symptoms don't bother me so why should I use the pills?
   I'm feeling well so why take the pills?
   I'd rather go hack to the hospital, so I don't bother with the pills.
Lately I haven't been able to afford the co-pays for medicine or I've had trouble getting transportation to the pharmacy.
Since my last appointment, I sometimes got confused about when to take the medicine.
At this time I have some fears about the medicine.
   I'm afraid I might get addicted to the medicine.
   I'm afraid people will find out I have a mental illness if they see me taking the pills.
   I had a bad reaction once and am afraid it will happen again.
   I'm concerned about the negative things I am hearing about this medicine.
   I have other fears or concerns about medicine.
Recently, I find it hard to believe that taking medicine is the right thing to do.
   I think medicine is a crutch and a sign of weakness.
   I think I should be able to get well on my own.
   I don't believe I am mentally ill.
   My religious beliefs say I should not rely on medicine.
   People who are important to me say I should not use the medicine.
   I have other beliefs that make me unsure about using the medicine.
At this time, I am exploring whether or not I really need to take the medicine or if other things will help me.
   I'm wondering what will happen if I stop the medicine.
   I'm feeling good now, so why take medicine?
   I'm exploring natural, cultural or spiritual healing methods.
   I'm exploring what happens if I only take the pills when I'm having a hard time.
   There are other ways I am trying to figure out whether I need the medicine or not.
At this time I feel I am not getting the support or information I need to make my own decisions about medicine.
   I need more information to help me make my decision about taking or not taking medicine.
   I need more information about my legal rights.
   I need more support from my doctor or nurse to make my decision about using this medicine.
   I need more support from my family to make my decision about using this medicine.
   I need someone to spend more time with me to help me make my decision about using medicine.

Various interventions can be used in order to reduce the decisional uncertainty of the patient related to the use of medications. For example, a chart listing the pros and cons of using the medication can be generated by the psychiatric patient 12 to help the psychiatric patient 12 to effectively weigh the side effects of the medication against the benefits the medication provides. In another example, additional information about the medicine and its usage can help the psychiatric patient 12 feel more at ease taking the medicine. In another example, the psychiatric patient 12 can attend a support group of others taking the medication. In another example, the patient can learn to use a mood chart to track mood changes related to use of personal medicine and psychiatric medicine. In another example, the patient can chart their use of drugs or alcohol and psychiatric medicine when compared to symptom levels and summarize findings in a longitudinal graph summarizing correlations. In another example, patients can explore their motivation to use medicine. In another example, patients can request that a significant other be a designated observer during a trial of a new medication and observations are kept in a daily log and later reported to the doctor.

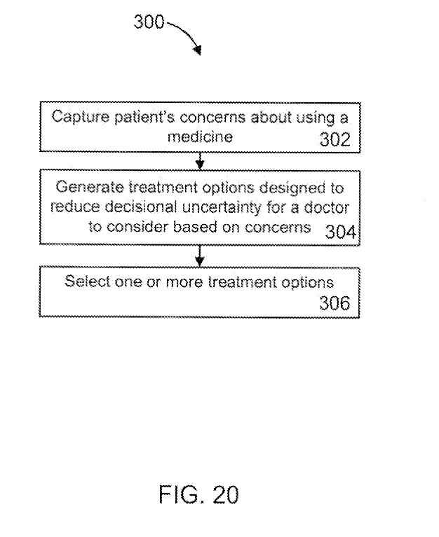

FIG. 20 shows a process 300 for generating a list of potential intervention tools automatically based on the inputs received from the psychiatric patient 12 about the patient's concerns related to the use of one or more medications. The system captures information about a patient's concerns, e.g., as described above (302) and automatically generates a report that includes a list of potential interventions or treatment options provided to reduce decisional uncertainty (304). These potential interventions or treatment options are presented to the doctor 13 who can consider using one or more of the potential interventions or treatment options (306).

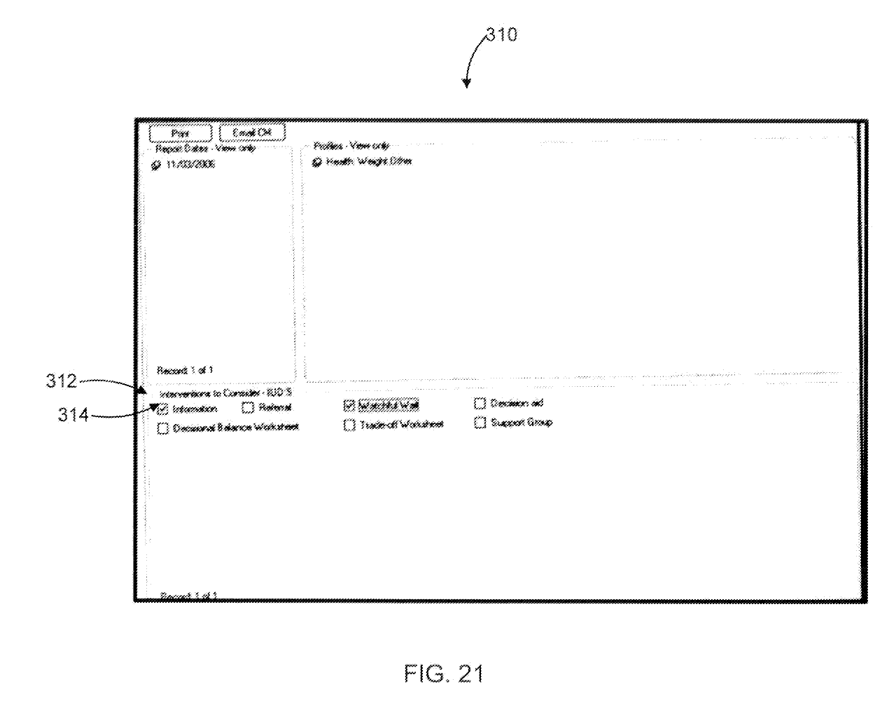

FIG. 21 shows an example of report 310 automatically generated based on the user's concerns about medication. The report 310 includes a list of interventions 312 for the doctor 13 to consider suggesting to the patient 12 in order to reduce the patient's uncertainty about taking a particular medication. The doctor can select to use a particular intervention by selecting the box next to the intervention (e.g., as shown by checked box 314). A list of interventions selected by the doctor can be sent to a support team who helps the patient 12 to implement the suggested interventions.

For example, in FIG. 21, the patient 12 has indicated a concern that the medicine may produce weight gain and be a threat to his/her health. The system captures the patient's concerns about using medicine and presents the report 310 to the doctor. The system also generates an array of treatment interventions for the doctor 13 and psychiatric patient 12 to consider to help the patient work through or resolve the decisional uncertainty. For instance, if the patient's concern is health and weight gain, the system generates an intervention called “watchful wait” that allows the patient to monitor his/her weight while using the medicine. This intervention may help to resolve the patient's decisional uncertainty because the concern about using the medicine has been addressed.

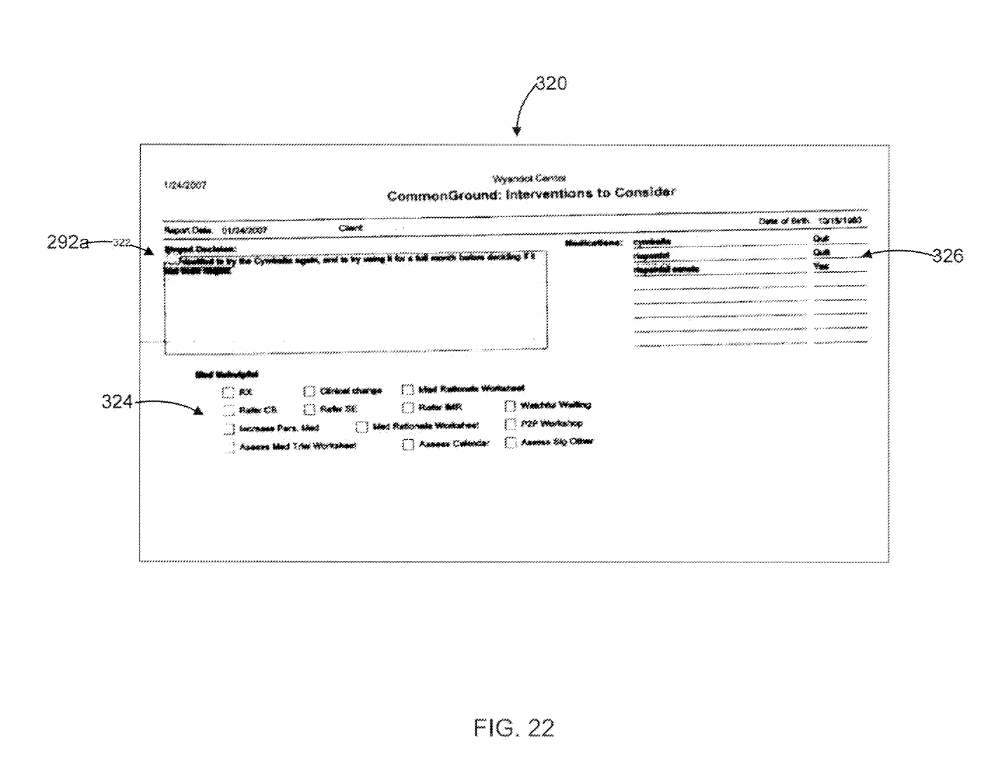

FIG. 22 shows another exemplary report 320 of interventions for the doctor 13 to consider. The report 320 includes a shared decision that the patient 12 and the doctor 13 make together to address the patient's concern about using the medicine. The report 320 also includes a list of the medications prescribed to the psychiatric patient 12 and the patient's current indicated usage of the medications. The report 320 also includes a list 324 of potential interventions for the doctor 13 to consider suggesting that the patient use to reduce his/her uncertainty about the medication.

Goals for Appointment with Doctor

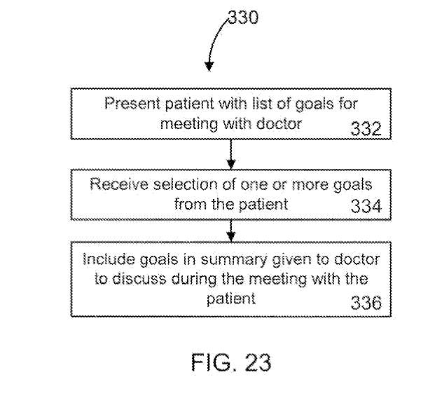

As shown in FIG. 23, in order to help organize the psychiatric patient's thoughts and questions for an appointment with a doctor 13, process 330 allows the psychiatric patient 12 to indicate his/her goals for the appointment. Process 330 includes presenting, on a user interface, a list of potential goals the psychiatric patient 12 may have for his/her meeting with a doctor (332). For example, Exemplary goals can include getting information, asking a question, getting medications changed, sharing progress, getting information about rights, and/or discussing concerns. The psychiatric patient 12 selects which of the goals applies to him/her and the system records the patient's selections (334).

Process 330 generates a report that includes a listing of the patient's goals for the appointment that is given to the doctor to discuss during the meeting with the psychiatric patient 12. It is believed that allowing the psychiatric patient 12 to select his/her goals prior to the appointment helps the patient 12 to determine what questions he/she would like to ask that doctor 13. In addition, providing the goals to the doctor 13 allows the doctor to focus the appointment on the concerns most relevant to the psychiatric patient 12.

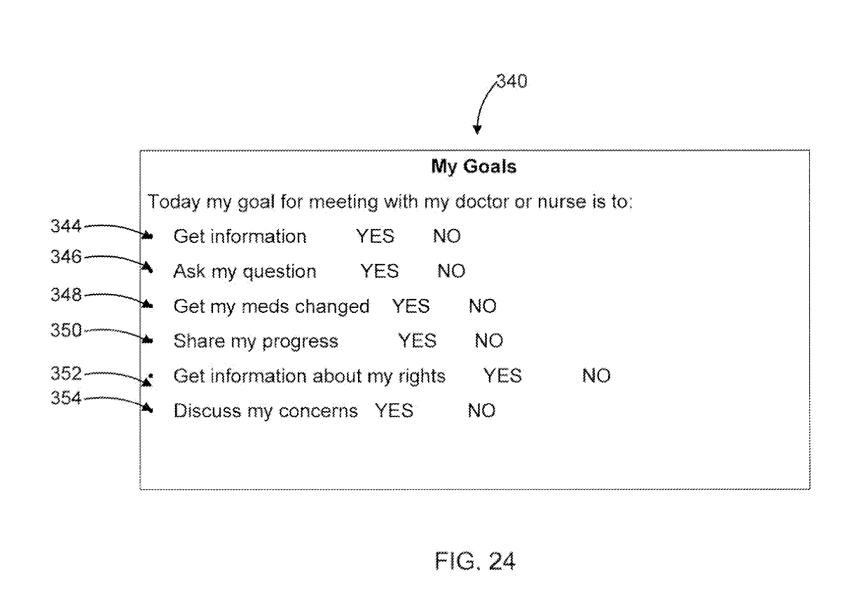

FIG. 24 shows an exemplary user interface 340 for presenting potential goals for a psychiatric patient 12 to select his/her goals for a meeting with the doctor 13. The psychiatric patient 12 can select which goals he/she has for a particular meeting by selecting yes or no to each item in a list of potential goals 344, 346, 348, 350, 353, and 354.

Reporting

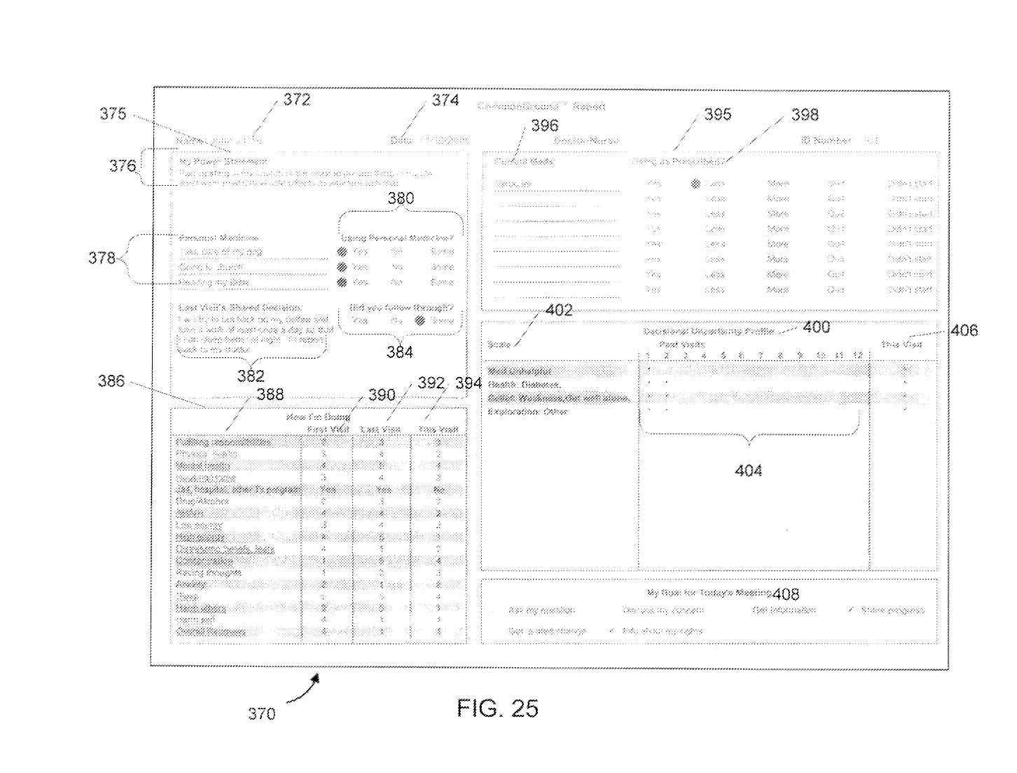

The information provided by the psychiatric patient 12 is used to generate a report that is used by the psychiatric patient 12 and doctor 13 to jointly make decisions about treatment of the patient's disorder. In some embodiments, as shown in FIG. 25, the report is a single-page report 370 that summarizes the information provided by the patient 12. Report 370 includes the patient's name 372 and the date 374 on which the psychiatric patient 12 provided the information.

The report 370 also includes a section 375 related to the user's power statement, personal medicines, and shared decisions. Section 375 includes a listing of the patient's power statement. Section 375 also includes a list 378 of the patient's personal medicines and indications of whether the psychiatric patient 12 has been using the personal medicines 380. Section 375 also includes the patient's shared decision from the last visit 382 and an indication 384 of the extent to which the psychiatric patient 12 has followed through with his/her shared decision.

The report 370 additionally includes a section 386 related to the patient's well-being. Section 386 includes a list of characteristics of how the patient is doing (e.g., as shown in column 388) and an indication of how the user rated how he/she was doing related to each aspect during the first visit, the last visit, and the current visit (e.g., as shown in columns 390, 392, and 394).

The report 370 includes a section 395 related to how the patient is using his/her prescribed medications. Section 395 includes a list of medications currently prescribed for the psychiatric patient 12 (e.g., as shown in column 396) and an indication of how the patient 12 is currently using the medication (e.g., as shown in columns 398).

The report 370 also includes a section 400 related to the patient's decisional uncertainty and concerns related to use of medications. Section 370 lists concerns the psychiatric patient 12 either has currently or has had in the past related to the use of medication (e.g., as shown in column 402). Section 400 plots which visits the patient has indicated that they have the concern (e.g., as shown in section 404). This information provides a historical perspective that the doctor 13 and psychiatric patient 12 can use to address the patient's concerns and uncertainty. In addition, section 400 includes a column 406 that indicates which concerns the patient 12 currently has with respect to using the medication.

The report 370 also includes a section 403 that lists the patient's goals for the appointment with the doctor 13. Listing the patient's goals for the appointment on the report 370 can help the patient 12 and doctor 13 to ensure that the patient's concerns are addressed during the appointment.

In addition to generating a summary report for the patient 12 and doctor 13 to discuss during an appointment, the information input by the psychiatric patient 12 can also be used to generate historical graphs of the patient's recovery progress. For example, the psychiatric patient 12 or doctor 13 can select various variables and query a database 21 to plot the patient's recovery progress as related to the particular variable. For example, the historical use of a particular treatment tool or medication can be plotted with respect to some desired outcome or quality of life of the patient to determine if use of the treatment tool or medication is correlated to the patient's recovery. Such historical data can be useful to both the psychiatric patient 12 and the doctor 13 in determining whether to continue with a particular type of treatment.

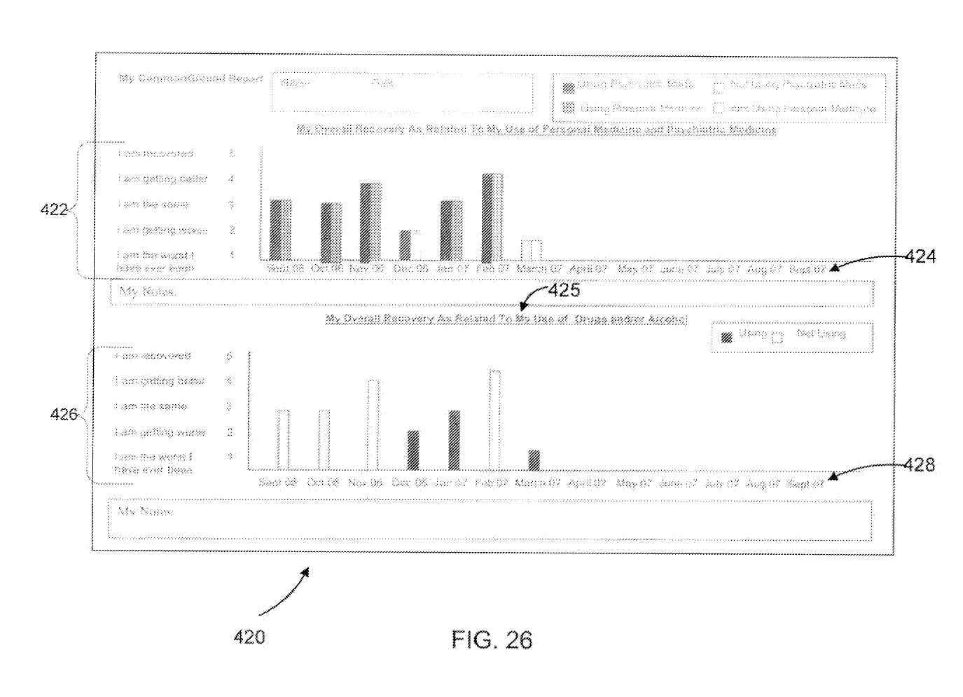

FIG. 26 shows two exemplary historical data graphs 420 and 425. Graph 420 plots the patient's overall recovery (as shown on axis 422) as related to use of his/her personal medicines and psychiatric medications over time (as shown on axis 424). Graph 425 plots the patient's overall recovery (as shown on axis 426) as related to use of drugs and alcohol over time (as shown on axis 428).

While the above description has focused primarily on systems and methods for treating psychiatric patients using a shared decision making schema in which the patient and the doctor together decide on a treatment plan, the systems and methods can also be used to treat other long-term disorders such as high blood pressure, asthma, diabetes, Rheumatoid arthritis, HIV/AIDS, and epilepsy.

The system, e.g., the kiosk, databases, etc. and methods described herein can be implemented in digital electronic circuitry, or in computer hardware, firmware, software, web-enabled applications, or in combinations thereof. Data structures used to represent information provided by the patient can be stored in memory and in persistence storage. Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits).

An example of one such type of computer is shown in FIG. 27, which shows a block diagram of a programmable processing system (system) 511 suitable for implementing or performing the apparatus or methods described herein. The system 511 includes a processor 520, a random access memory (RAM) 521, a program memory 522 (for example, a writeable read-only memory (ROM) such as a flash ROM), a hard drive controller 523, and an input/output (I/O) controller 524 coupled by a processor (CPU) bus 525. The system 511 can be preprogrammed, in ROM, for example, or it can be programmed (and reprogrammed) by loading a program from another source (for example, from a floppy disk, a CD-ROM, or another computer).

The hard drive controller 523 is coupled to a hard disk 130 suitable for storing executable computer programs, including programs embodying the present invention, and data including storage. The I/O controller 524 is coupled by an I/O bus 526 to an I/O interface 527. The I/O interface 527 receives and transmits data in analog or digital form over communication links such as a serial link, local area network, wireless link, and parallel link.

Other implementations are within the scope of the following claims:

What is claimed is:

1. A method for use in treating a psychiatric disorder, the method comprising:
generating by a computer a user interface, the user interface including a plurality of questions phrased from the point of view of a psychiatric patient;
displaying the user interface on a display device;
receiving responses from the psychiatric patient to the plurality of questions; and
generating a report based on the responses.

2. The method of claim 1, further comprising generating a suggested intervention based on the responses.

3. The method of claim 1, wherein generating the plurality of questions in the user interface, comprises:
generating a question about the psychiatric patient performance of a non-pharmacological activity used to assist the psychiatric patient in recovery; and
receiving responses from the psychiatric patient comprises:
receiving an indication of the extent to which the psychiatric patient has performed the activity.

4. The method of claim 1, wherein
generating the plurality of questions in the user interface comprises:
generating a statement of a shared decision, the shared decision being an activity to be performed by the psychiatric patient that was previously determined by the patient and doctor; and
receiving responses from the psychiatric patient comprises:
receiving an indication from the psychiatric patient regarding whether the psychiatric patient performed the shared decision.

5. The method of claim 1, wherein
generating the plurality of questions in the user interface comprises:
generating a plurality of questions regarding the extent to which the patient encountered symptoms associated with the psychiatric disorder; and
receiving responses from the psychiatric patient comprises:
receiving an indication from the psychiatric patient of the extent to which the psychiatric patient encountered the symptoms.

6. The method of claim 1, wherein
generating the plurality of questions in the user interface comprises:
generating one or more questions related to the use of prescribed medications; and
receiving responses from the psychiatric patient comprises:
receiving responses from the psychiatric patient regarding the use of the prescribed medications.

7. The method of claim 6, wherein generating one or more questions related to the use of prescribed medications comprises:
presenting the user with input options that indicate whether the patient used the medication as prescribed, the input options comprising at least some of yes, no, used more, used less, and did not start.

8. The method of claim 6, further comprising:
determining if the psychiatric patient used a particular medication as prescribed based on the response from the psychiatric patient;
if the user did not use the particular medication as prescribed, generating a list of common concerns related to the user of the medication;
presenting the list of common concerns to the psychiatric patient on the user interface; and
receiving a response from the user, the response indicating the degree to which the patient has the concern.

9. The method of claim 1, wherein
generating the plurality of questions in the user interface comprises:
presenting the psychiatric patient with a list of potential goals for a meeting with a doctor; and
receiving responses from the psychiatric patient comprises:
receiving a response from the psychiatric patient related to the psychiatric patient's goals.

10. The method of claim 1, wherein generating the report comprises generating the report prior to an appointment with a physician.

11. The method of claim 1, wherein the questions phrased from the point of view of the psychiatric patient are phrased in first person singular.

12. The method of claim 1, further comprising generating a report including a graph of historical recovery data.

13. The method of claim 12, wherein the graph of historical recovery data comprises a graph of the psychiatric patient's recovery progress as related to the use of one or more prescription medications.

14. The method of claim 12, wherein the graph of historical data comprises a graph of the psychiatric patient's recovery progress as related to the use of drugs or alcohol.

15. A method for use in treating a psychiatric disorder, the method comprising:
generating a question about a psychiatric patient's performance of a non-pharmacological activity used to assist the psychiatric patient in recovery;
receiving a first response that includes indication of the extent to which the psychiatric patient has performed the activity;
generating a statement of a shared decision, the shared decision being an activity to be performed by the psychiatric patient that was previously determined by the patient and doctor;
receiving a second response that includes an indication from the psychiatric patient regarding whether the psychiatric patient performed the shared decision;
generating a plurality of questions regarding the extent to which the patient encountered symptoms associated with the psychiatric disorder;
receiving a third response that includes an indication from the psychiatric patient of the extent to which the psychiatric patient encountered the symptoms;
generating one or more questions related to the psychiatric patient's use of prescribed medications; and
receiving a fourth response that includes responses from the psychiatric patient regarding the use of the prescribed medications;
generating a report based on one or more of the first, second, third, and fourth responses; and
generating one or more suggested interventions based on one or more of the first, second, third, and fourth responses.

16. The method of claim 15, further comprising:
determining if the psychiatric patient used a particular medication as prescribed based on the response from the psychiatric patient;
if the user did not use the particular medication as prescribed, generating a list of common concerns related to the user of the medication;
presenting the list of common concerns to the psychiatric patient on the user interface; and
receiving a response from the user, the response indicating the degree to which the patient has the concern.

17. The method of claim 15, wherein the questions are phrased from the point of view of the psychiatric patient.

18. The method of claim 15, wherein the questions are phrased in first person singular.

19. The method of claim 15, further comprising generating a report including a graph of historical recovery data.

20. A method for use in treating a psychiatric disorder, the method comprising:
retrieving information about a psychiatric patient from a database, the information including information about prescribed medications and information about a non-pharmacological activity used to assist the psychiatric patient in recovery,
generating, by a computer, a user interface, the user interface including a plurality of questions based on the retrieved information about the psychiatric patient, the questions being phrased from the point of view of the psychiatric patient;
displaying the user interface on a display device;
receiving responses from the psychiatric patient to the plurality of questions;
storing the responses in a memory included in the computer; and
generating a report based on the responses.

21. The method of claim 20, wherein
generating the plurality of questions in the user interface, comprises:
generating a question about the psychiatric patient's performance of the non-pharmacological activity used to assist the psychiatric patient in recovery; and
generating one or more questions related to the use of prescribed medications; and
receiving responses from the psychiatric patient comprises:
receiving an indication of the extent to which the psychiatric patient has performed the activity; and
receiving responses from the psychiatric patient regarding the use of the prescribed medications.

22. The method of claim 20, further comprising:
retrieving information about a shared decision from the database, the shared decision being an activity to be performed by the psychiatric patient that was previously determined by the patient and doctor; wherein
generating the plurality of questions in the user interface comprises:
generating a statement of a shared decision, and receiving responses from the psychiatric patient comprises:
receiving an indication from the psychiatric patient regarding whether the psychiatric patient performed the shared decision.

23. The method of claim 20, wherein the questions are phrased in first person singular.

24. A method for use in treating a long-term disorder, the method comprising:
generating by a computer a user interface, the user interface including a plurality of questions phrased from the point of view of a patient;
displaying the user interface on a display device;
receiving responses from the patient to the plurality of questions; and
generating a report based on the responses.
